(19) United States
(12) Patent Application Publication
(10) Pub. No.: US 2012/0144751 A1
(43) Pub. Date: Jun. 14, 2012

(54) PANE UNIT AND METHOD FOR PRODUCING IT

(76) Inventor: Nikolaj Schapitz, Besigheim (DE)

(21) Appl. No.: 13/313,506

(22) Filed: Dec. 7, 2011

(30) Foreign Application Priority Data
Dec. 8, 2010 (DE) 20 2010 013 082.4

(51) Int. Cl. B60J 1/17; B60J 10/04

(52) U.S. Cl. 49/431

(57) ABSTRACT

The invention relates to a pane unit for windows on motor vehicles and the like, with a first pane (12), with a frame (11) which has a multi-part frame profile with at least one secondary part (54) as a soft component and engages on a margin of the pane (12) on at least two sides of the pane (12), the frame (11) surrounding at least two end faces (13) of the pane (12) or annularly surrounding the pane (12) so as to be closed on itself, and with a guide web (15) for guiding a second pane (14) which is movable up and down and is arranged towards the first pane (12), wherein a reception region (38) for a panel element (17) is provided on the frame (11) so as to point towards the outside (32) of a body.

The invention relates to a pane unit for windows on motor vehicles and the like, which comprises a first pane with a frame which surrounds the margin of the pane on at least two sides, the frame engaging on at least two end faces of the pane or annularly surrounding the pane so as to be closed on itself, and with a guide web for guiding a second movable pane, which guide web is arranged fixedly on the first pane, and also to a method for producing it.

Window guide webs are generally known in the prior art. FR 2 858 950 discloses a two-part window guide web which, by two halves being plugged together, receives a fixed window provided with an injection-moulded surround and, opposite this, a window guide element, in order to guide a moved window to be opened and closed.

Further technical background for such a pane unit with a triangular window is given in EP 1 499 512 B1 which shows a window guide web provided for receiving a sealing element into which the pane of the fixed window can be inserted.

The disadvantage of these embodiments is the complicated mounting of the window with the guide web and with the panel element in the corresponding body part of the motor vehicle, such as, for example, a rear door. Furthermore, subsequent exchange or mounting of the panel element on the pane unit is not possible, and therefore individual design requirements have to be taken into account and implemented as early as in the production process. The panel elements may be damaged during the production process and the installation of the pane unit and cannot be exchanged very simply. In order to reduce the risk of damage, cost-intensive protective measures are necessary.

The object of the invention is to make available an improved pane unit which avoids the disadvantages described above.

A solution is provided by the features of claim 1. Alternative embodiments are described in the subclaims.

Due to the configuration of a reception region for a panel element on a frame, pointing towards the outside of a body, of the pane unit, it becomes possible that the panel element can be put in place and fastened also after the complete mounting of the pane unit in the body of the vehicle door. In particular, the panel element will be put in place and fastened only after the complete mounting of the pane unit in the body of the vehicle door. A basic module of a pane unit can thus be provided which is subsequently adapted according to the design requirements. Furthermore, damage to the panel element during the installation of the pane unit can also be prevented.

A preferred embodiment is provided in that the guide web is connectable to at least one subsequently mountable panel element. This embodiment makes it possible, according to the respective decorative requirements, and after the installation of the pane with the guide web, subsequently to mount a corresponding panel element to the customer's taste.

In a further preferred refinement of the invention, the guide web is designed as an introduction part which is at least partially injection-moulded around by the secondary part and is fastened to the first pane. As a result of this arrangement, guide webs can be used which are produced in a separate operation and which are positioned, and held fixed, with respect to the pane via the secondary part which is formed as a soft component.

In a preferred embodiment of the guide web designed as an introduction part, this guide web is formed in one part or is multi-part. Particularly in the multi-part embodiment of the guide web, the guide web can be plugged together before introduction into an injection-moulding die, thus giving rise to a one-part guide web which is at least partially injection-moulded around by the secondary part. Alternatively, one part of the guide web may also be introduced into the injection-moulding die and be injection-moulded onto the first pane by means of the secondary part and, before installation in the body, a second guide part may be plugged onto the first guide part.

In a further alternative embodiment of the pane unit, the guide web is formed as a part or portion of the primary part of the multi-part frame profile and is injection-moulded on the first pane. In this case, the guide web is preferably produced simultaneously with the formation of the primary part for forming the frame. Thus, both the guide web and the primary part can be produced simultaneously, in a first step in the production of a frame, as a two-component or multi-component injection-moulded surround.

According to an alternative embodiment of the pane unit, an outside of the guide web has, for forming the reception region of the panel element, a very thin bearing face, over which the secondary part is injection-moulded as a soft component. By virtue of this alternative embodiment, individual tolerances can be balanced more effectively. Furthermore, in such an embodiment, improved vibration damping can be made possible.

In a further preferred refinement of the invention, the reception region for the panel element is formed by an outside of the guide web and a portion, adjacent thereto, of the secondary part which is adjacent to the guide web or its outside. This refinement makes it possible that the transitional region between the secondary part and the guide web, designed as an introduction part or as a primary part, is covered by the panel element. In addition, the secondary part may have an undercut region on which a longitudinal side of the panel element can be inserted, so that this undercut acts as additional fixing for a longitudinal side of the panel element.

A further preferred refinement of the invention provides on the guide web holding elements which are preferably formed for snapping, claw fastening, keyhole locking or clamping with the panel element. As a result, depending on the respective applications, an appropriate type of fastening can be selected which also depends on the possibilities for subsequent fastening of the panel element to the already mounted pane unit.

Moreover, the guide web has at least one bearing face free of an injection-moulded surround. In this case, in particular, an outside, pointing towards the vehicle outside, of the guide web remains free, so that the panel element can be put in place onto and bears against that outside of the guide web which is not injection-moulded around.

As an advantageous embodiment, the guide web forms at least one U-shaped guide face for the window guide of the second pane. In this case, the guide face may be formed by a U-shaped profile in the direction of the end face of the second pane.

The invention is explained below by means of the drawings in which:

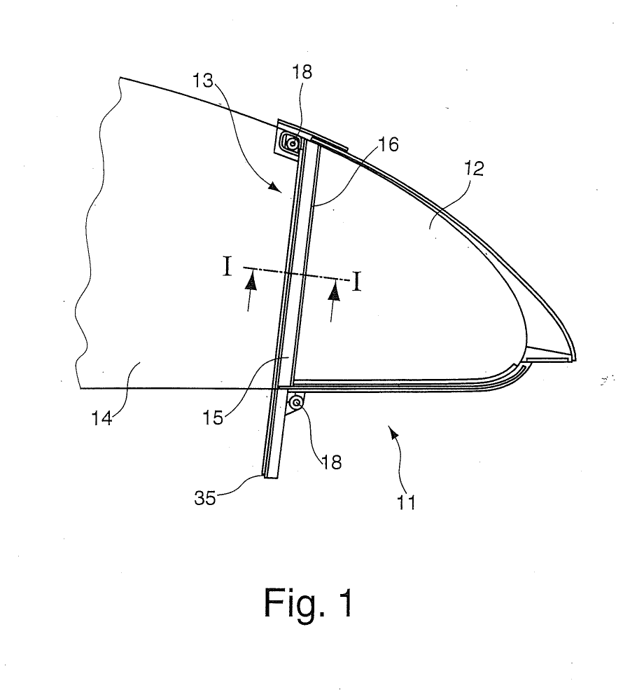

FIG. 1 shows a diagrammatic side view of a pane unit on a side lying on the outside on the vehicle,

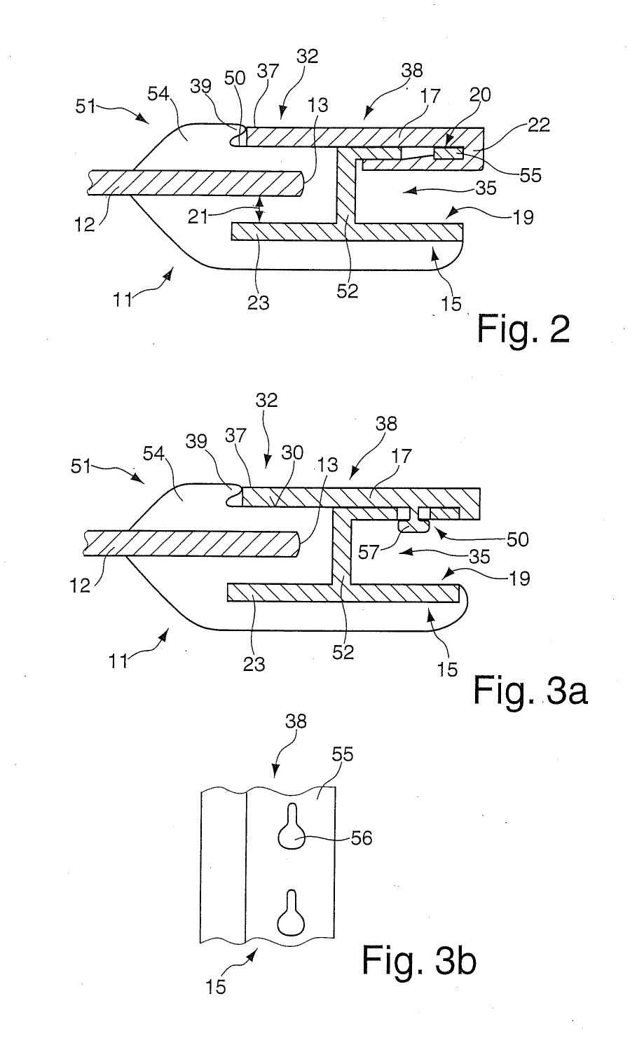

FIG. 2 shows a diagrammatic sectional illustration of a guide web of the pane unit along the line I-I in FIG. 1,

FIG. 3a shows a diagrammatic sectional illustration of an alternative embodiment to FIG. 2,

FIG. 3b shows a top view of a reception region of the guide web according to FIG. 3a,

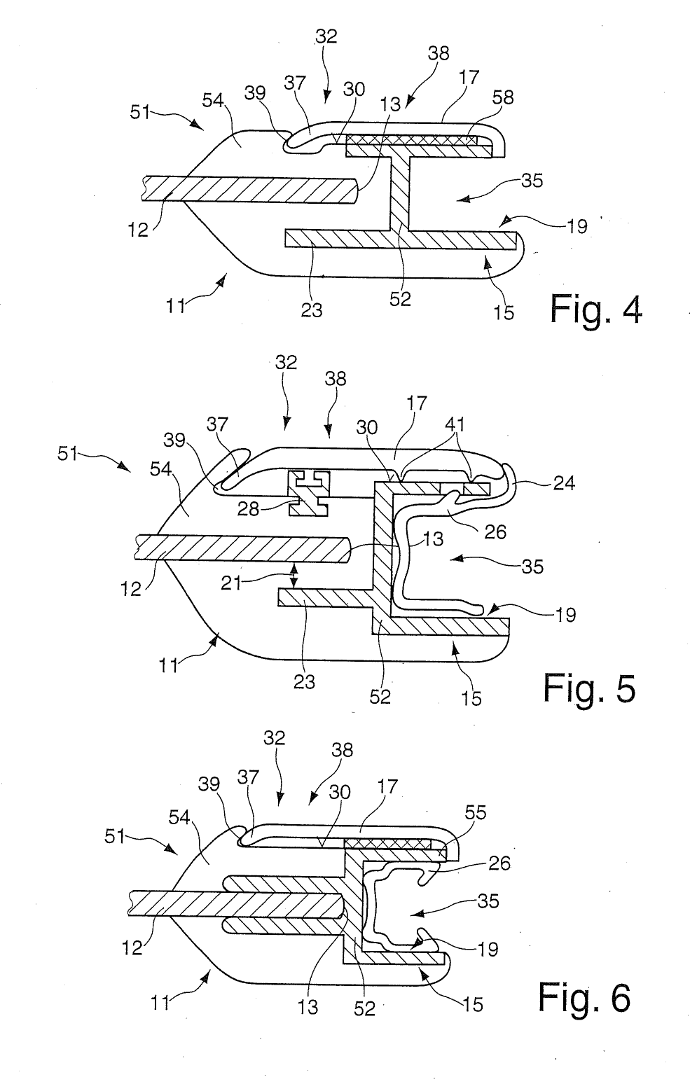

FIG. 4 shows a diagrammatic sectional illustration of an alternative guide web of the pane unit along the line I-I in FIG. 1,

FIG. 5 shows a diagrammatic sectional illustration of an alternative guide web of the pane unit along the line I-I in FIG. 1, and

FIG. 6 shows a diagrammatic sectional illustration of an alternative guide web of the pane unit along the line I-I in FIG. 1.

FIG. 1 shows a pane unit 51 with a frame 11 in a side view of the side lying on the outside on the vehicle. This pane unit 51 comprises a first pane 12 which can be mounted fixedly in a door of a motor vehicle. In this case, the first pane 12 is assigned, on the vertical end face 13, to a second pane 14 movable up and down. Between the first pane 12 and the second pane 14 is arranged a guide web 15 which is continued downwards into the door beyond the end face 13 of the first pane 12. The first pane 12 comprises a frame 11 which, in this exemplary embodiment, surrounds the pane 12 completely and in a closed manner. Arranged on the guide web 15 is a panel element 17, the subsequent attachment and fastening of which are described in more detail in the following figures. Fastening elements 18 are preferably arranged and injection-moulded directly on the frame 11. These fastening elements 18 may also be formed as separate structural parts and be arranged subsequently on the frame 11 after the production of the latter. The pane unit 51 is mounted, for example, in a door of the motor vehicle via these fastening means 18 or fastening elements.

FIG. 2 illustrates a pane unit 51 in a cross section perpendicular to the longitudinal axis of the guide web 15 according to section I-I in FIG. 1. The pane unit 51 has a guide web 15 with a panel element 17 pushed on a U-profile 19. The panel element 17 is locked on the guide web 15, for example, by means of hook fastenings 20. These hook fastenings 20 may be provided multiply along the panel element 17 or the guide web 15. In this pane unit 51, the guide web 15 is designed as an introduction part which has, for example, the profile of a letter “h”. Alternatively, this profile may also correspond to the letter “H”. In the embodiment illustrated, a clearance 21 is preferably provided between the pane 12 and a web portion 23. In this embodiment, the pane unit 51 comprises a frame 11 which comprises a multi-component, in particular two-component injection-moulded surround, there being provided, at least in the region of the sectional illustration, a secondary part 54 which is formed as a soft component and by which the guide web 15 is positioned and fixed with respect to the end face 13 of the pane 12. In addition, in the further regions of the pane 12, a primary part 52, which is formed as a hard component and is at least partially injection-moulded around by the secondary part 34, can also engage on the pane. In the case of a two-component injection-moulded surround, the frame 11 consists of the primary part 52 formed as the hard component and of the secondary part formed as the soft component, the soft component having lower dimensional stability than the hard component. Alternatively, in this embodiment, it may also be provided that the guide web 15 is produced from the hard component and forms a part of the primary part 52, which is injection-moulded directly on the pane 12. The tie-up of the guide web 15 to the pane 12 is illustrated, for example, in FIG. 6. Alternatively, there may also be provision whereby the guide web 15, when being injection-moulded directly onto the pane 12, bears against and engages on only one side face and/or the end face 13.

Towards the outside 32 of the frame 11, the guide web 15 has a reception region 38 for the panel element 17 with a bearing face 30. This bearing face 30 has adjoining it a further bearing face which is formed by the secondary part. The panel element 17 bears with its inside preferably over the full area of the bearing face 30. At an end 37 of the panel element 17 which faces the secondary part 54, the reception region 38 preferably comprises an undercut 39 in which the end 37 of the panel element 17 comes to bear flush or which engages behind said end. A defined and also leak-tight arrangement or termination between the secondary part 54 and the guide web 15 can thereby take place. The panel element 17 has, in turn, a region which is designed as a U-profile 22, matches with the hook fastenings 20 and surrounds a leg 55 of the guide web 15.

FIG. 3a shows a pane unit 51 with the frame 11 according to FIG. 2, with the panel element 17 which alternatively is fastened to the guide web 15 by means of keyhole locking 50. The leg 55 may in this case be designed in such a way that a nipple 57 or mushroom head can engage into a keyhole orifice 56 according to FIG. 3b in such a way that its outside is formed flush with an inside, pointing towards the window guide 35, of the guide web 15. Alternatively, the latter may also project slightly, in which case a window guide element 26, as illustrated by way of example in FIGS. 5 and 6, which can be inserted into the window guide 35, is adapted thereto in order to compensate for this projection. The panel element 17 may have, on an end face pointing towards the second pane 14, a bent-round portion which covers the leg 55 of the guide web 15 in order to achieve a visually pleasing termination with respect to the second pane 14.

The further possibilities of configuration and variation which were described with regard to FIG. 2 also apply to this embodiment.

FIG. 3b shows a top view of the reception region 38 of the guide web with the keyhole locking 50 according to FIG. 3a. In this case, the keyhole-shaped orifices 56 are formed in order in the longitudinal direction of the guide web 15 on the reception region 38 of the latter, into which orifices the key-shaped nipples 57 of the panel element 17 according to FIG. 3a can engage and latch.

FIG. 4 illustrates a further alternative embodiment to FIG. 2. This embodiment deviates from that of FIG. 2 in that the leg 55 of the guide web 15 is of closed form, so that a closed bearing face 30 is present as a reception region, for example in order to apply an adhesive 58 for an adhesive bond partially or, in particular, over the full area and to fix the panel element 17. This adhesive bond 58 may also be a double-sided adhesive strip which extends over the width of the outside of the guide web 15 or else also comprises an adjacent region of a bearing face of the secondary part 54. In the embodiment of the guide web 15 that is illustrated in FIG. 4 an “H”-like profile is provided for example. The bearing face 30, which is formed from the hard component, can thereby be widened.

Furthermore, the alternatives described in FIG. 2 also apply to these embodiments.

FIG. 5 illustrates a further alternative embodiment to the embodiments illustrated above. The profile of the guide web 15 is formed contrarily to that in FIG. 2. The portion 23 is provided offset with respect to the U-shaped profile 19. Parallel thereto, and with a clearance 21, a further portion 23 may also be provided on the opposite side of the pane 12.

The guide web 15 has arranged in it, for example, a window guide element 26 having an end portion 24 which, together with the undercut region 39 of the secondary part 54, delimits the reception region 38 for receiving the panel element 17.

In this embodiment, a further alternative possibility for fastening the panel element 17 is illustrated. For example, an additional fastening element may be provided in the form of an introduction part 28 in the secondary part 54 which fixes the panel element 17 by latching, snapping or the like. This introduction part can, in turn, be inserted into the secondary part 54 and fastened by latching or snapping or may be formed as an introduction part partially injection-moulded around by the secondary part 54 or as an integral part of the primary part 52 as a hard component.

In this embodiment, the panel element 17 has projections 41 which serve for defined bearing contact of the panel element 17 against an outside of the guide web 15 within the reception region 38.

The further alternatives described with regard to FIG. 2 also apply to this embodiment.

FIG. 6 illustrates a further alternative embodiment of the pane unit 51. This embodiment deviates in that the guide web 15 is designed as the primary part 52 and forms part of an injection-moulded surround 16 of the pane 12. After the window guide web 15 and the primary part 52 have been produced, in a further method step the secondary part 54 is produced by injection-moulding around. In this case, there is provision whereby the bearing face 30 of the guide web 15 is formed so as to be free of an injection-moulded surround. Alternatively, this outside of the guide web 15 or the outside of the leg 55 may have a very thin injection-moulded surrounding layer which is formed as a soft component. The guide web 15 may be injection moulded on directly in the marginal region of the pane 12. Alternatively, a primer or an adhesive may be applied beforehand in the marginal region. Alternatively, the window guide web 15 may also be designed as a separate introduction part according to the profile in FIG. 6 and be plugged onto the pane 12. The secondary part fixes the guide web 15 with respect to the pane 12. In addition, an adhesive or primer may also be inserted between the guide web 15 and the pane 12.

All the abovementioned alternatives to the respective embodiments also apply to this exemplary embodiment, and vice versa. In this exemplary embodiment, the panel element 17 is fastened by means of the adhesive bonding 58. The above-described fastening possibilities for positioning and fixing the panel element 17 in the reception region 38 are likewise possible.

In this embodiment, there is provision whereby an end portion of the panel element at least partially surrounds the leg 55, so that the latter is not visible from outside. As illustrated in FIG. 6, the bearing face 30 in the reception space 38 may be formed by the secondary part 54 and the outside of the leg 55 of the guide web 15, these forming a common plane. Alternatively, a portion of the bearing face 30 on the guide web may also be formed so as to be offset to a portion on the secondary part, as is illustrated, for example, in FIG. 5. This bearing face 30 and its extent and/or contouring depend on the fastening elements or fastening technique used for the panel element 17 in the reception region 38.

The advantage of the invention is that it is simple to mount the pane unit 51 in the corresponding body part of the motor vehicle, such as, for example, a rear door. The panel element 17 can be exchanged or mounted subsequently. Individual design requirements can thus be implemented after the actual process of producing the pane unit, with the result that the risk of damage is reduced and cost-intensive protective measures for the panel element 17 may be dispensed with.

This application claims priority of German Patent Application No. 20 2010 013 082.4 filed Dec. 8, 2010, which is hereby incorporated herein by reference in its entirety.

1. Pane unit for windows on motor vehicles and the like,
with a first pane,
with a frame which has a multi-part frame profile with at least one secondary part as a soft component and engages on a margin of the pane on at least two sides of the pane, the frame surrounding at least two end faces of the pane or annularly surrounding the pane so as to be closed on itself, and
with a guide web for guiding a second pane which is movable up and down and is arranged towards the first pane, characterized in that a reception region for a panel element is provided on the frame so as to point towards the outside of a body.

2. Pane unit according to claim 1, wherein at least one panel element is mountable subsequently on the guide web.

3. Pane unit according to claim 1, wherein the guide web is designed as an introduction part which is at least partially injection-moulded around by the secondary part and which is fixed with respect to the first pane.

4. Pane unit according to claim 3, wherein the guide web is arranged in a clearance with respect to the first pane.

5. Pane unit according to claim 3, wherein the guide web is formed in one piece or is multi-part.

6. Pane unit according to claim 1, wherein the guide web is formed as part of a primary part of the frame and is injection-moulded on the first pane.

7. Pane unit according to claim 6, wherein the guide web formed as the primary part is at least partially injection-moulded around by the secondary part, and the secondary part engages sealingly at least on one side of the first pane.

8. Pane unit according to claim 1, wherein the guide web has at least one bearing face, free of an injection-moulded surround, in the reception region, against which bearing face the panel element bears.

9. Pane unit according to claim 1, wherein the guide web has a very thin bearing face, over which the secondary part is injection-moulded as a soft component, in the reception region.

10. Pane unit according to claim 1, wherein the reception region for the panel element is formed by an outside of the guide web and a portion, adjacent thereto, of the secondary part on the guide web.

11. Pane unit according to claim 1, wherein the guide web forms a U-shaped window guide for the second pane.

12. Pane unit according to claim 1, wherein the guide web has holding elements.

13. Pane unit according to claim 12, wherein the holding elements are formed for the snapping, claw fastening, keyhole locking, clamping or adhesive bonding of the panel element on the guide web.

14. Pane unit according to claim 1, wherein the panel element is designed as an introduction part and is at least partially injection-moulded around by the secondary part and is also fixed with respect to the guide web.

15. Pane unit according to claim 1, wherein a marginal portion, delimiting the reception region, of the secondary part has an undercut or a bordering margin.
